(19) United States
(12) Patent Application Publication
(10) Pub. No.: US 2021/0293265 A1
(43) Pub. Date: Sep. 23, 2021

(54) JOINING ASSEMBLY AND SECURING DEVICE FOR USE IN A JOINING ASSEMBLY

(71) Applicant: GRIPPLE LIMITED, Sheffield, South Yorkshire (GB)

(72) Inventor: Lee Giemza, Yorkshire (GB)

(21) Appl. No.: 17/284,747

(22) PCT Filed: Oct. 22, 2019
(86) PCT No.: PCT/IB2019/058998

§ 371 Date: Apr. 12, 2021

(30) Foreign Application Priority Data
Nov. 5, 2018 (GB) 1818036.4
Oct. 17, 2019 (GB) 1915008.5

(51) Int. Cl. F16B 7/04; F16G 11/08; F16G 11/10; F16B 7/22

(52) U.S. Cl. CPC F16B 7/0406; F16G 11/08; A01G 17/06; F16G 11/10; F16B 7/22; F16G 11/101

(57) ABSTRACT

Joining Assembly and Securing Device for use in a Joining Assembly (FIG. 1) A securing device (12) for use in a joining assembly (10) is disclosed. The securing device (12) comprises a clamping mechanism (30) for securing an elongate article (100) to the securing device (12). A connecting arrangement (20) is co-operable with a connecting arrangement on a further securing device (14), thereby connecting the securing device (12) to a further securing device (14). The joining assembly (10) comprises two of the securing devices (12, 14).

This invention relates to joining assemblies. More particularly, but not exclusively, this invention relates to joining assemblies for joining elongate articles. This invention also relates to securing devices for use in joining assemblies. Embodiments of the invention relate to joining assemblies for joining wires, cables, wire ropes or the like.

In vineyards, vines are grown along trellises which comprise a plurality of wires strung between posts. During harvesting of the grapes, cutters are used to cut bunches of grapes from the vines. The cutters sometimes inadvertently cut the wires. The ends of the cut wire then has to be joined together. This can be difficult if the wire was under tension before it was cut.

According to one aspect of this invention, there is provided a joining assembly comprising two securing devices, each securing device comprising a respective clamping mechanism and a respective connecting arrangement, wherein the connecting arrangements are co-operable with each other to connect the securing devices to each other.

According to another aspect of this invention, there is provided a securing device for use in a joining assembly described above, said securing device comprising a clamping mechanism, and a connecting arrangement co-operable with a further connecting arrangement on a further securing device, thereby connecting the securing device to the further securing device.

Each securing device may comprise a body. The body may define a bore. The clamping mechanism may be disposed within the bore.

The bore may be a blind bore having a closed end. The body may be closed at one end to provide the closed end of the bore.

The connecting arrangement of each securing device may be attached to the body. The connecting arrangement of each securing device may be so attached at the closed end of the body.

Each securing device may comprise proximal and distal ends. The connecting arrangement may be attached to the body at the proximal end of the securing device.

The connecting arrangement of each securing device may comprise a holding member configured to cooperate with the holding member of the other securing device.

The holding member may be configured for holding the holding member of the other securing device. The holding member may comprise a hook formation.

The holding member may include a main engaging surface, which may be a re-entrant surface. The main engaging surface may face the body.

The main engaging surface of each of the securing devices may engage each other when the securing devices are connected to each other.

The connecting arrangement of each securing device may include a linking portion extending between the holding member and the body.

The holding member may be spaced from the body by the linking portion. A space may be defined between the holding member and the body.

The linking portion may have a linking surface extending from the main engaging surface. The linking surface may extend to the body.

The body may have a central axis. The linking surface may extend axially relative to the central axis of the body. In one embodiment, the linking surface may be parallel to the central axis of the body.

The holding member may include a subsidiary engaging surface. The subsidiary engaging surface may engage the linking surface of the other securing device. The subsidiary engaging surface may extend from the main engaging surface.

The subsidiary engaging surface may extend axially relative to the central axis of the body. The subsidiary engaging surface may be parallel to the linking surface.

The holding member may define an aperture and may include a projecting portion. The projecting portion may project from the main engaging surface.

The projecting portion may project towards the body. The aperture may extend from the main engaging surface. The aperture may be a through aperture.

The projecting portion of the holding member of each securing device desirably co-operates with the aperture defined by the holding member of the other securing device when the securing devices are connected to each other.

The central axis may extend between the aperture and the projecting portion. The aperture and the projecting portion may be disposed on opposite sides of the central axis.

The aperture defined by the holding member of each securing device may be arranged to receive the projecting portion of the holding member of the other securing device.

The connecting arrangement of each securing device may be spaced from the body by a distance to provide a gap between the body and the connecting arrangement of the other securing device when the securing devices are connected to each other by the connecting arrangements.

The joining assembly may comprise a locking clip to lock the securing devices to each other when the securing devices are connected to each other.

The locking clip may be received in the gaps between the body of each securing device and the connecting arrangement of the other securing device. The body may define a first recess. The first recess may be defined in the closed end of the body. The holding member may define a second recess.

The holding member may have a proximal end surface, which may extend from the subsidiary surface. The second recess may be defined by the proximal end surface. The proximal end surface may face away from the body. The second recess may face away from the body.

Each of the first and second recesses may be a cylinder segment. Each cylinder segment may be a minor cylinder segment. The first recesses of each securing device may face the second recesses of the other securing device when the securing devices are connected to each other.

When the securing devices are connected to one another, the first recess defined by the body of each securing device may be disposed opposite the second recess defined by the holding member of the other securing device.

The locking clip may comprise a cover part for engaging around the connecting arrangements of the securing devices when the securing devices are connected to each other. The cover part may comprise a shroud formation.

The locking clip may further include insertion members to be inserted in the gaps defined between the body of each securing device and the holding member of the other securing device. The insertion members may extend from the cover part.

Each insertion member may include protruding portions to be received by the recesses defined by the body of each securing device and the holding member of the other securing device. Each protruding portion may be substantially cylindrical.

The clamping mechanism of each securing device may be disposed in the body.

The clamping mechanism may comprise a clamping member movable between a clamping condition and a release condition. The clamping mechanism may further include an urging member for urging the clamping member to the clamping condition.

The body may define a bore. The clamping mechanism may be disposed within the bore. The bore may be a blind bore having a closed end. The body may be closed at one end to provide the closed end of the bore.

The urging member may comprise a spring, which may be a compression spring. The urging member may be disposed in the bore between the clamping member and the closed end.

The clamping member may define a groove in which an elongate article can be received. The clamping member may have first and second ends. The urging member may engage the first end.

The clamping member may have an outer surface. The outer surface may taper inwardly from the first end to the second end.

The bore may have an opening defined by the body. The opening may be defined at the opposite end of the bore to the closed end. The opening may be defined at the distal end of the securing device.

The bore may have an inner surface that tapers inwardly from the closed end to the opening. The clamping member may extend through the opening.

The body may have a central axis. The bore may extend along the central axis. The central axis may extend through the connecting arrangement.

The clamping mechanism of each securing device may comprise two of the clamping members arranged in an opposed position relative to each other.

The clamping members may be movable between a clamping condition and a release condition.

The urging member may be disposed between the clamping members and the closed end. The urging member may urge both of the clamping members to the clamping condition.

Both clamping members may extend through the opening. The clamping members may be disposed opposite one another across the central axis.

The joining assembly may join elongate articles to each other. The elongate articles may be in the form of wires, cables, wire ropes or the like.

The clamping mechanism of each securing device may clamp a respective elongate article. The clamping members may be urged into clamping engagement with the elongate article by the tapering inner surface of the bore.

An embodiment of the invention will now be described by way of example only, with reference to the accompanying drawings, in which:

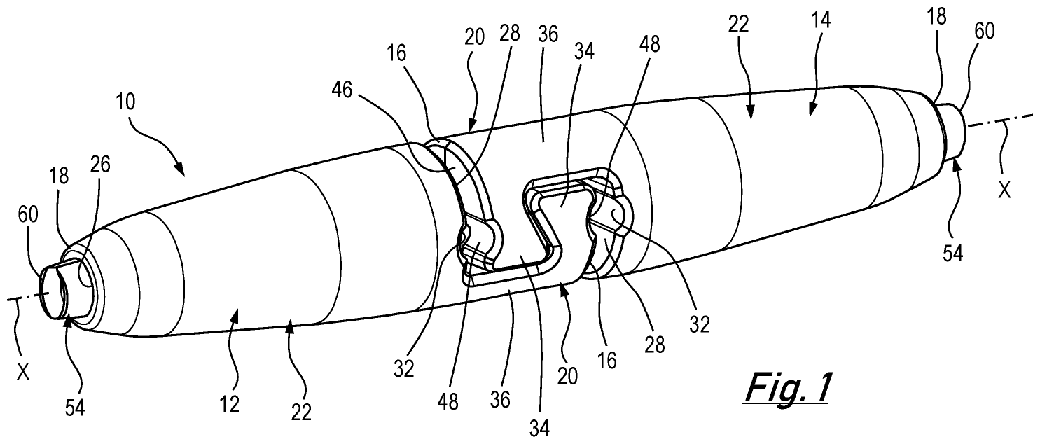

FIG. 1 is a perspective view of a joining assembly comprising two securing devices;

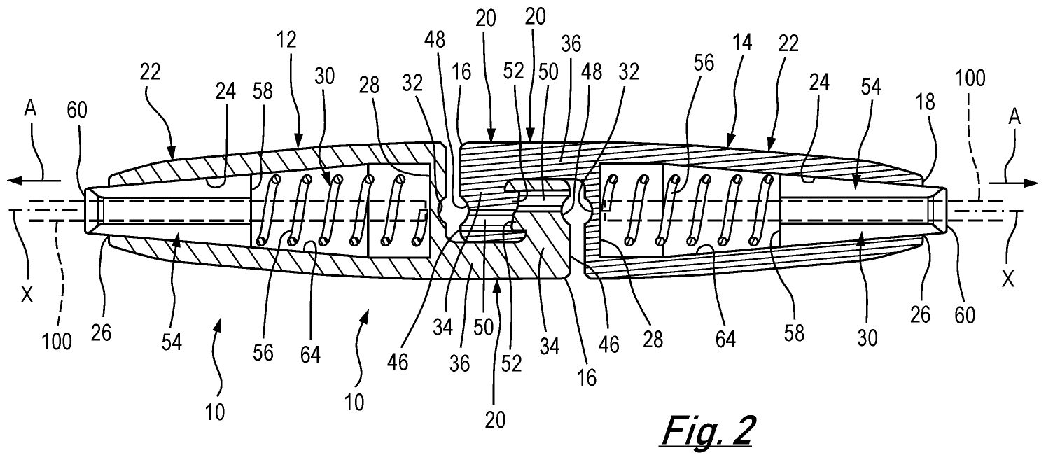

FIG. 2 is a sectional view of the joining assembly;

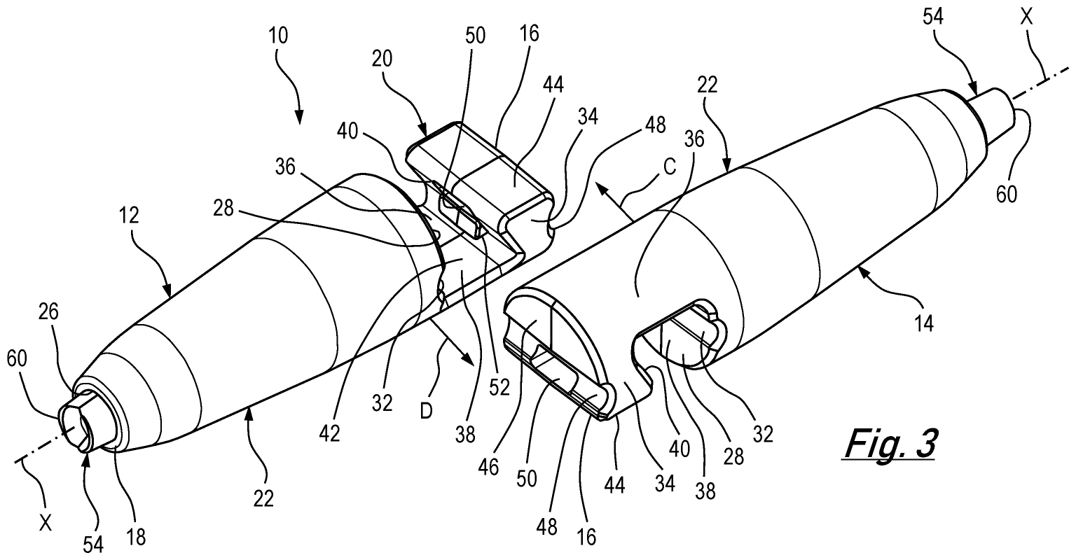

FIG. 3 is a perspective view showing the securing devices in a position ready to be connected to each other;

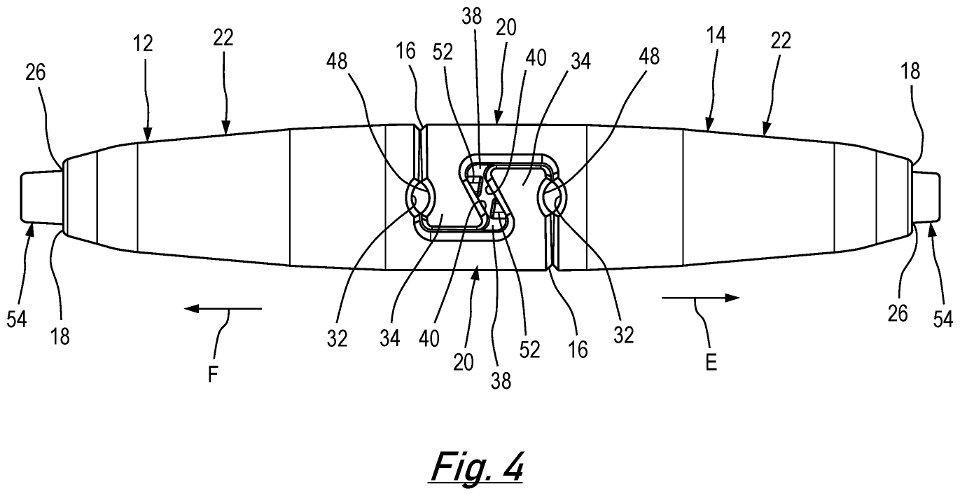

FIG. 4 is a side view of the securing devices in the process of being connected to each other;

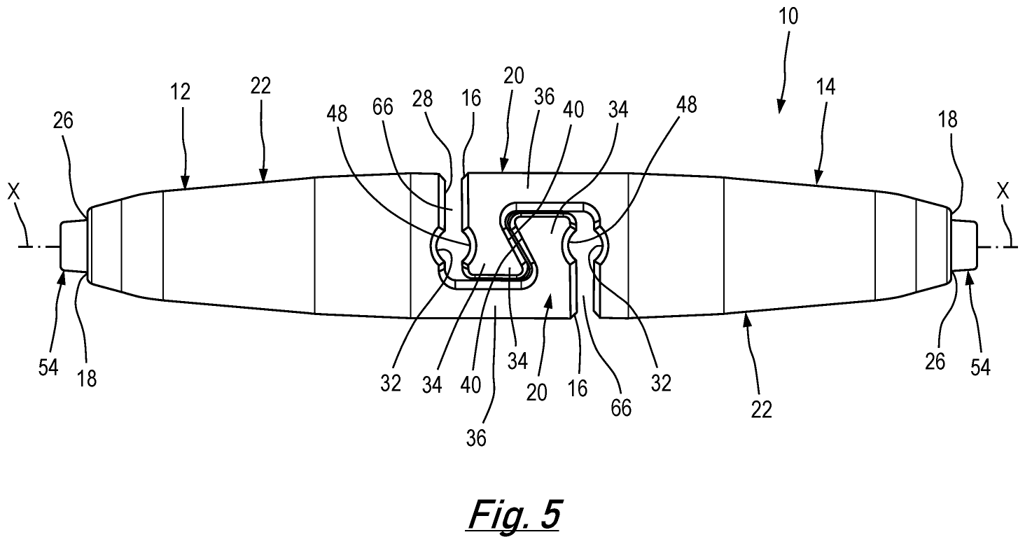

FIG. 5 is a side view of the securing devices connected to each other, thereby forming the joining assembly;

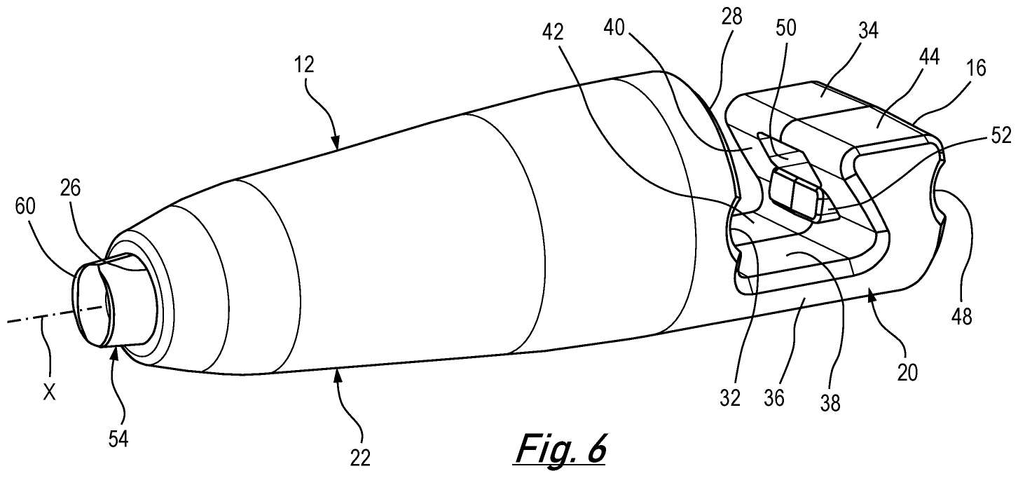

FIG. 6 is a close up perspective view of one of the securing devices;

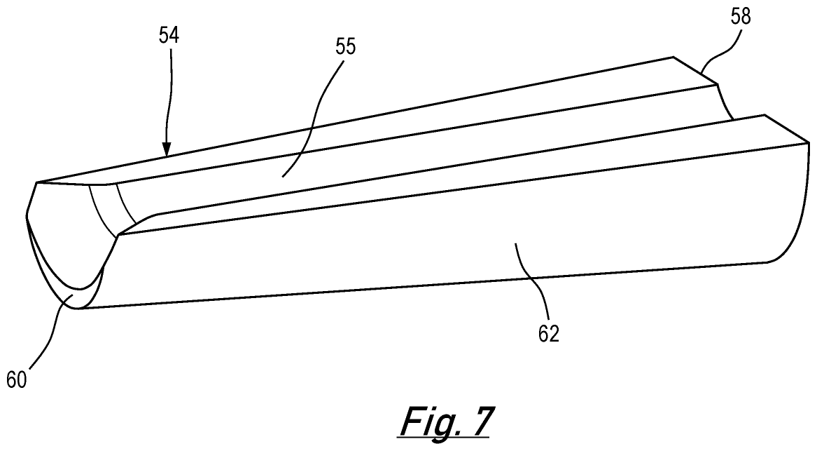

FIG. 7 shows a clamping member for use in each securing device;

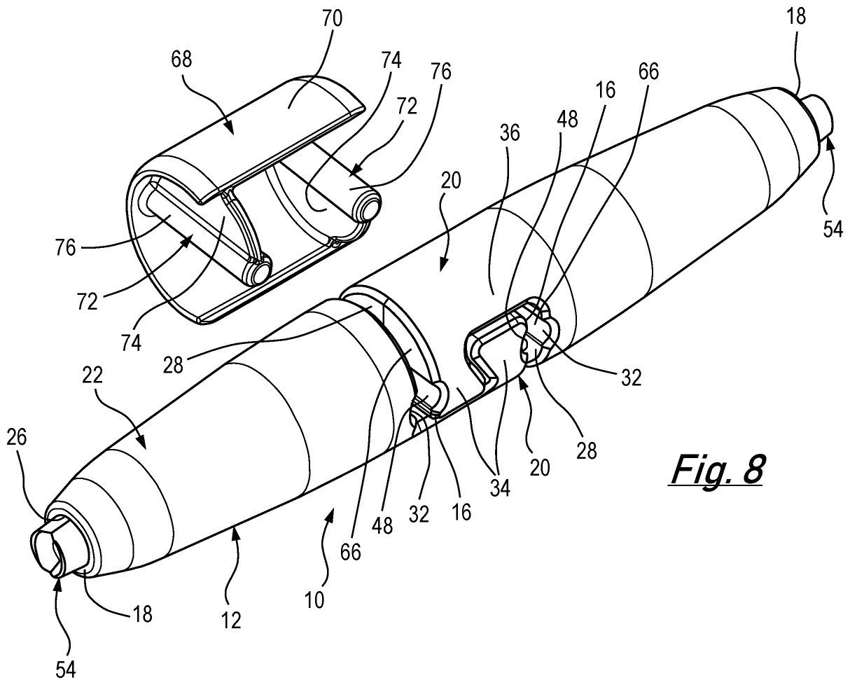

FIG. 8 shows the joining assembly in which the securing devices are about to be locked to each other by a locking clip;

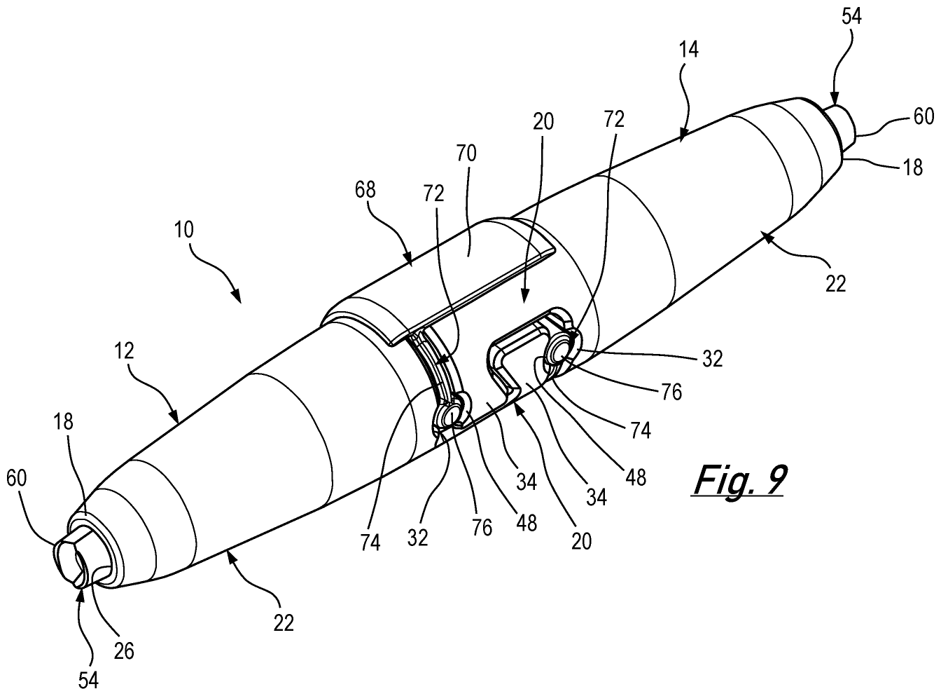

FIG. 9 shows the joining assembly in which the securing devices are locked to each other by the locking clip; and

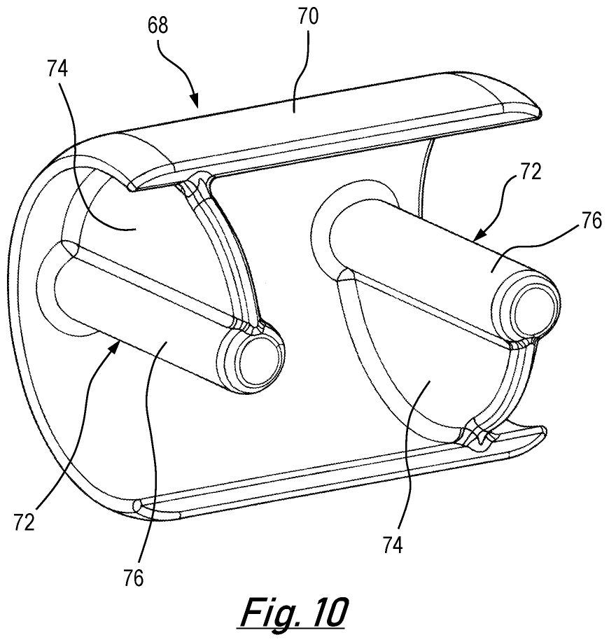

FIG. 10 is a close up perspective view of the locking clip.

The drawings show a joining assembly 10 for joining elongate articles 100 (shown in broken lines in FIG. 2) to each other. The elongate articles 100 may be in the form of wires, cables, wire ropes or the like.

The joining assembly 10 is particularly suitable for use in agricultural situations, in which elongate articles 100 in the form of wires are strung between supports to form a trellis, and the crop, such as vines, are grown along the wires.

During harvesting, one or more of the wires can be inadvertently cut. Joining assemblies 10 can then be used to repair the wires by joining the cut ends.

The joining assembly 10 comprises two identical securing devices 12 and 14.

Each of the securing devices 12, 14 has a proximal end 16 and a distal end 18. Each securing device 12, 14 comprises a connecting arrangement 20 to connect the securing device 12 to the securing device 14. The connecting arrangements 20 are provided at the proximal ends 16 of the respective securing devices 12, 14.

Each of the securing devices 12, 14 further includes a body 22 having a central axis X. A blind bore 24 is defined by the body 22, the bore 24 having an opening 26 in the body 22 at the distal end 18 of the respective securing device 12, 14.

The bore 24 has a closed end 28 opposite the opening 26, and extends along the central axis X. A clamping mechanism 30 is provided in the blind bore 24 (see FIG. 2) to clamp the elongate article 100, thereby securing the elongate articles 100 to the securing devices 12, 14.

A first recess 32 is defined in the closed end 28 of the body 22. The first recess 32 is in the shape of a minor cylinder segment. The first recess 32 extends across the closed end 28 of the body 22.

The connecting arrangement 20 of each securing device 12, 14 is attached to the closed end 28 of the body 22 and extends therefrom along the central axis X.

The connecting arrangement 20 comprises a holding member 34 and a linking portion 36 attaching the holding member 34 to the body 22. The holding member 34 is in the form of a hook formation.

The holding member 34 is spaced from the body 22 by the linking portion 36, thereby defining a space 38 between the holding member 34 and the body 22 (see FIG. 6).

The holding member 34 has a re-entrant main engaging surface 40 (see FIG. 6) facing the closed end 28 of the body 22. The main engaging surface 40 of the holding members 34 of each of the securing devices 12, 14 engage one another when the securing devices 12, 14 are connected to one another. This is described in more detail below.

The linking portion 36 has a linking surface 42 (see FIG. 6) extending from the main engaging surface 40 to the closed end 28 of the body 22. The linking surface 42 extends parallel to the central axis X.

The holding member 34 further includes a subsidiary engaging surface 44 extending from the main engaging surface 40. The subsidiary engaging surface 44 extends parallel to the central axis X and the linking surface 42.

A proximal end surface 46 extends from the subsidiary engaging surface 44 transverse to the subsidiary engaging surface 44. In the embodiment shown, the proximal end surface 46 extends substantially perpendicular to the subsidiary engaging surface 44.

The proximal end surface 46 extends parallel to the closed end 28 of the body 22, and defines a second recess 48. The second recess 48 is in the shape of a minor cylinder segment. The second recess 48 extends across the proximal end surface 46.

The holding member 34 defines an aperture 50 extending from the main engaging surface 40 through the holding member 34. The holding member 34 further includes a projecting portion 52 extending from the main engaging surface 40.

The projecting portion 52 is arranged between the aperture 50 and the linking portion 36. The purpose of the aperture 50 and the projecting portion 52 is to prevent lateral movement when the securing devices 12, 14 are clamped to the elongate articles 100, and connected to each other, as discussed below.

The clamping mechanism 30 comprises a pair of opposed clamping members 54 disposed in the bore 24. One of the clamping members 54 is shown in FIG. 7. An urging member in the form of a spring 56 is arranged between the clamping members 54 and the closed end 28 of the bore 24.

Each clamping member 54 has first and second ends 58, 60 (see FIG. 7). The clamping members 54 are disposed in the bore 24 with the first end 58 closest to the closed end 28 of the bore 24. The second end 60 may extend out of the bore 24 through the opening 26 in the body 22.

Each clamping member 54 has a longitudinally extending groove 55 to receive the elongate article 100 to be clamped.

Each clamping member 54 has a tapering outer surface 62 which, in use, engages the inner surface 64 of the bore 24. The outer surface 62 tapers inwardly from the first end 58 to the second end 60.

The inner surface 64 of the bore 24 of each securing device 12, 14 tapers inwardly from the closed end 28 to the opening 26. The spring 56 engages the first end 58 of both clamping members 54 and urges the clamping members 54 towards the opening 26.

As a result, when an elongate article 100 is received in the bore 24 between the clamping members 54, the clamping members 54 are urged into engagement with the elongate article 100, thereby receiving the elongate article 100 in the grooves 55 defined by the clamping members 54.

Subsequently, when the user pulls the elongate article 100 towards the opening 26, as indicated by the arrows A in FIG. 2, the elongate article 100 drags the clamping members 54 of each securing device 12, 14 in the same direction as the respective elongate article 100.

The tapering inner surface 64 of the bore 24 urges the clamping members 54 towards each other into tight clamping engagement with the respective elongate article 100.

When the elongate article 100 is so clamped, the clamping members 54 may extend out of the bore 24 from the opening 26 in the body 22. The clamping members 54 can be released by pushing them in the direction opposite to the arrows A in FIG. 2.

In situations where the diameter of the elongate articles 100 is sufficiently large, or the tension in the elongate articles is not very high, the clamping members 54 may not extend out of the bore 24 from the opening 26.

When the elongate articles 100 are clamped by the clamping mechanism 30 of each of the securing devices 12, 14, the securing devices 12, 14 can be connected to each other. One of the securing devices 12, 14 is disposed in an orientation in which it is rotated by 180° about the central axis X relative to the other of the securing devices.

Referring to FIG. 3, the securing devices 12, 14 are arranged adjacent each other facing in opposite directions, so that the holding member 34 of the first securing device 12 is aligned with the space 38 defined between the body 22 and the holding member 34 of the second securing device 14. In this position, the holding member 34 of the second securing device 14 is aligned with the space 38 defined between the body 22 and the holding member 34 of the first securing device 12.

The securing devices 12, 14 can then be moved towards each other, as shown by the arrows C and D in FIG. 3. This moves the securing devices 12, 14 to the position shown in FIG. 4 in which the holding member 34 of the first securing device 12 is received in the space 38 defined between the holding member 34 and the body 22 of the second securing device 14. In this position, the holding member 34 of the second securing device 14 is received in the space 38 defined between the holding member 34 and the body 22 of the first securing device 12.

The securing devices 12, 14 are then moved relative to each other, as indicated by the arrows E and F in FIG. 4, so that the main engaging surfaces 40 engage each other, as shown in FIG. 5. This is the position of the securing devices 12, 14 shown in FIGS. 1 and 2.

In this position, the projecting portion 52 of the holding member 34 of the first securing device 12 is received in the aperture 50 defined by the holding member 34 of the second securing device 14.

Correspondingly, the projecting portion 52 of the holding member 34 of the second securing device 14 is received in the aperture 50 defined by the holding member 34 of the first securing device 12. See FIG. 2.

The securing devices 12, 14 are prevented from lateral movement relative to each other by the engagement of the projecting portions 52 in the apertures 50. The securing devices 12, 14 thereby remain connected to each other by tension in the elongate article 100.

When the securing devices 12, 14 are connected to each other, the first recess 32 of the first securing device 12 is disposed so that it faces, and is aligned with, the second recess 48 of the other of the second securing device 14.

Correspondingly, the first recess 32 of the second securing device 14 faces, and is aligned with, the second recess 48 of the securing device 14.

When the securing devices 12, 14 are so connected to each other, a gap 66 is defined between the proximal end 16 of the first securing device 12 and the closed end 28 of the body 22 of the second securing device 14.

A gap 66 is also defined between the proximal end 16 of the second securing device 14 and the closed end 28 of the body 22 of the first securing device 12.

The joining assembly 10 further includes a locking clip 68 to lock the securing devices 12, 14 to each other when the securing devices 12, 14 are connected to each other.

The locking clip 68 comprises a partially cylindrical shroud formation 70 for engaging around the connecting arrangements 20 of the securing devices 12, 14 when the securing devices 12, 14 are connected to each other.

The locking clip 68 further includes two insertion members 72 to be inserted in the gaps 66 defined between the body 22 of each securing device and the holding member 34 of the other securing device. The insertion members 72 extend through the centre of the shroud formation 70.

Each insertion member 72 includes a web portion 74 and a respective protruding portion in the form of a cylindrical portion 76. Each cylindrical portion 76 is attached to the web portion 74. Each web portion 74 is received in a respective one of the gaps 66. The cylindrical portions 76 are received by the aligned first and second recesses 32, 48.

In the embodiment described herein, the shape of the body 22 is such that a user can grip the securing devices 12, 14 in which the cut ends of an elongate article 100 have been clamped.

The user can pull the securing devices 12, 14 together against the tension force in the elongate article 100 and connect the securing devices 12, 14 to each other, thereby repairing the elongate article 100.

There is thus described a joining assembly 10, an embodiment of which is suitable for joining the ends of an elongate article 100 that has been inadvertently cut. The joining assembly 10 allows the elongate article 100 to be repaired even if the elongate article 100 was under tension.

A clip 68 is provided to lock the first and second securing devices 12, 14 to each other. The joining assembly 10 has the advantage that it has a low profile, thereby helping to ensure it is not caught up in harvesting machines.

The securing devices 12, 14 are slightly wider than the wire, thereby allowing a user to grip both securing devices 12, 14 to pull them together.

The joining assembly 10 has the further advantage that it does not require the use of additional material, such as lengths of wire to be used.

The two securing devices 12, 14 are identical so that only one type of component need be manufactured, thereby minimising costs.

Various modifications can be made without departing from the scope of the invention.

1. A joining assembly comprising two securing devices, each securing device comprising:
a respective clamping mechanism, each clamping mechanism being for securing respective elongate articles to the securing devices; and
a respective connecting arrangement, wherein the connecting arrangements are co-operable with one another to connect the securing devices to each other;
each securing device further including a body defining a bore, the clamping mechanism being disposed within the bore;
the clamping mechanism comprising a clamping member movable between a clamping condition and a release condition, and the clamping mechanism further including an urging member for urging the clamping member to the clamping condition;
wherein each connecting arrangement comprises a respective holding member, the holding members being configured to cooperate with one another to connect the securing devices to each other.

2. A joining assembly according to claim 1, wherein each securing device comprises proximal and distal ends, each connecting arrangement being attached to the body at the proximal end of the respective securing device, and each clamping mechanism being provided at the distal end of the respective securing device.

3. (canceled)

4. A joining assembly according to claim 1, wherein the body of each securing device has a closed end, and the bore defined by each body is a blind bore, being closed at the closed end of the body, the connecting arrangement of each securing device being attached to the body at the closed end of the body.

5. A joining assembly according to claim 4, wherein each bore has an opening defined by the respective body, each opening being defined at the opposite end of the respective bore to the closed end, and each bore having an inner surface that tapers inwardly from the closed end to the opening.

6. A joining assembly according to claim 1, wherein each body has a central axis, each bore extending along the respective central axis.

7. (canceled)

8. A joining assembly according to claim 1, wherein each holding member includes a main engaging surface, whereby the main engaging surface of each holding member can engage the main engaging surface of the holding member of the other securing device to connect the securing devices to each other.

9. A joining assembly according to claim 8, wherein each connecting arrangement includes a linking portion extending between the respective holding member and the respective body, each holding member being spaced from the respective body by the linking portion.

10. A joining assembly according to claim 9, wherein each linking portion has a linking surface extending from the respective main engaging surface to the respective body, and wherein each body has a central axis, each linking surface extending axially relative to the central axis of the respective body.

11. A joining assembly according to claim 10, wherein each holding member includes a subsidiary engaging surface extending from the respective main engaging surface axially relative to the central axis of the respective body, each subsidiary engaging surface of the respective securing device being configured to engage the linking surface of the other securing device when the securing devices are connected to each other.

12. A joining assembly according to claim 8, wherein each holding member defines an aperture and includes a projecting portion, each projecting portion projecting from the respective main engaging surface towards the respective body, and each aperture extending from the respective main engaging surface, wherein each projecting portion of the holding member of each securing device co-operates with the aperture defined by the holding member of a further the other securing device when the securing devices are connected to each other.

13. A joining assembly according to claim 1, wherein each holding member is spaced from the respective body by a distance sufficient to provide a gap between the body of each securing device and a holding member of the other securing device when the securing devices are connected to each other.

14. A joining assembly according to claim 1, comprising a locking clip to lock the securing devices to each other when the securing devices are connected to each other.

15. A joining assembly according to claim 14, wherein the locking clip is received in the gaps between the body of each securing device and the connecting arrangement of the other securing device.

16. A joining assembly according to claim 14, wherein the closed end of each body defines a first recess, and each holding member has a proximal end surface facing away from the respective body, each proximal end surface defining a second recess.

17. A joining assembly according to claim 16, wherein the first recesses of each securing device faces a respective one of the second recesses of the other securing device when the securing devices are connected to each other, whereby the first recess defined by the body of each securing device is disposed opposite the second recess defined by the holding member of the other securing device, and whereby the second recess defined by the holding member of each securing device is disposed opposite the first recess defined by the body of the other securing device.

18. A joining assembly according to claim 14, wherein the locking clip comprises a cover part for engaging around the connecting arrangements of the securing devices when the securing devices are connected to each other.

19. A joining assembly according to claim 14, wherein the locking clip further includes insertion members to be inserted into gaps defined between the body of each securing device and the holding member of each securing device.

20. A joining assembly according to claim 19, wherein each insertion member includes protruding portions to be received by the recesses defined by the body of each securing device and the holding member of each securing device, and by the holding member of the securing device and the body of a further securing device.

21. (canceled)

22. A joining assembly according to claim 1, wherein each clamping member defines a groove in which an elongate article can be received, and each clamping member has first and second ends, each urging member engaging the respective first end, and wherein each clamping member has an outer surface tapering inwardly from the respective first end to the respective second end.

23. A joining assembly according to claim 22, wherein the clamping mechanism of each securing device comprises two of the clamping members arranged in an opposed position relative to each other, the clamping members being movable between clamping and release conditions.

24. A joining assembly according to claim 23, wherein each urging member is disposed between the clamping members and the closed end of the respective securing devices, each urging member urging both of the clamping members of the respective securing device to the clamping condition.

25. (canceled)
